(19) United States
(12) Patent Application Publication
(10) Pub. No.: US 2026/0160236 A1
(43) Pub. Date: Jun. 11, 2026

(54) ENERGY GENERATION CELL AND ENERGY GENERATION DEVICE INCLUDING THE SAME

(71) Applicants: Hyundai Motor Company, Seoul (KR); Kia Corporation, Seoul (KR); Freudenberg Vilene Filtration Technologies Korea Co., Ltd., Pyeongtaek (KR)

(72) Inventors: Seung Yun Kwak, Hwaseong (KR); Sung Su Kim, Incheon (KR); Kyung Ho Hwang, Pyeongtaek (KR); Kwang Hyeok Lee, Pyeongtaek (KR)

(21) Appl. No.: 19/179,681

(22) Filed: Apr. 15, 2025

(30) Foreign Application Priority Data
Oct. 30, 2024 (KR) 10-2024-0150460

(51) Int. Cl. F03G 7/00; H01M 8/02

(52) U.S. Cl. CPC F03G 7/0252; F05B 2220/60; F05B 2230/90; F05B 2240/57; F05B 2240/90; F05B 2280/401; H01M 8/02

(57) ABSTRACT

Provided is an energy generation cell with a casing that has an upper opening and a bottom inflow hole for introducing water. A membrane inserted through the top generates electrical energy by harnessing the potential difference from water's movement and evaporation. A moisture absorption member in the membrane extends through the inflow hole to draw water from outside. Additional features may include a mesh to protect the membrane, a coating layer to prevent water impregnation, and conductive threads for electrodes. A separate energy generation device houses multiple such cells in a body with a separator, sealing O-rings, water inlet/outlet nozzles, and a detachable cover. By leveraging capillary action and evaporation, the system aims to improve efficiency, stability, and reliability of electrical power generation.

### CROSS-REFERENCE TO RELATED APPLICATION

This application claims under 35 U.S.C. § 119(a) the benefit of Korean Patent Application No. 10-2024-0150460 filed in the Korean Intellectual Property Office on Oct. 30, 2024, the entire contents of which are incorporated herein by reference.

### BACKGROUND

### Technical Field

The present disclosure relates to an energy generation cell and an energy generation device including the same, and more particularly, to an energy generation cell, which is capable of additionally harvesting electrical energy by using water, which is a by-product from a fuel cell system, to improve energy generation efficiency, stability, and reliability, and an energy generation device including the same.

### Background

With the growth of population and the development of industry, the demand for fossil fuels is increasing,, leading to resource depletion and rising international prices.

In addition, there is a growing movement to reduce the use of fossil fuel as it is recognized that fossil fuel causes global warming. Therefore, research is being conducted on renewable energy that utilizes solar energy, water, geothermal energy, and rain to generate energy.

Recently, development has focused on energy generation devices, specifically transpiration-driven electrokinetic power generators, which generate electrical energy based on potential differences created by the movement and evaporation of water.

That is, the energy generation device includes a hydrophilic fiber membrane (e.g., the non-woven fabric) coated with a conductive polymer layer (e.g., carbon layer). The energy generation device is configured to generate electrical energy on the basis of a potential difference between two opposite ends of the energy generation device created when water supplied to the energy generation device evaporates while moving (moving by capillarity) along the energy generation device (the hydrophilic fiber membrane).

Meanwhile, in order to improve energy generation efficiency, stability, and reliability of the energy generation device that generates electrical energy on the basis of the potential difference created by capillarity and evaporation, it is necessary to stably maintain an arrangement state of the energy generation device, specifically, energy generation membrane, and stably maintain an environment for ensuring capillarity and evaporation.

Therefore, recently, various studies have been conducted to stably maintain the environment for ensuring capillarity and evaporation while stably maintaining the arrangement state of the energy generation membrane that constitutes the energy generation device, but the study results are still insufficient. Accordingly, there is a need to develop a technology to stably maintain the environment for ensuring capillarity and evaporation while stably maintaining the arrangement state of the energy generation membrane.

### SUMMARY

The present disclosure has been made in an effort to provide an energy generation cell, which is capable of additionally harvesting electrical energy by using water, which is a by-product from a fuel cell system, to improve energy generation efficiency, stability, and reliability, and an energy generation device including the same.

In one aspect, an energy generation cell comprising: a) a casing having an upper side with an opening and having an inflow hole formed through a bottom surface to allow water to enter the casing; b a membrane inserted into the casing through the upper side with the opening, configured to generate electrical energy based on a potential difference between two opposite ends occurring when the water moves and evaporates; and c) a moisture absorption member disposed in the membrane to direct water toward the membrane, wherein the moisture absorption member suitably protrudes to outside of the casing through the inflow hole, and being configured to absorb the water.

In order to achieve the above-mentioned object of the present disclosure, an energy generation device includes an energy generation cell including: a casing having an upper side with an opening and having an inflow hole formed through a bottom surface of the casing so that water is introduced into the casing; a membrane inserted into the casing through the upper side with the opening and configured to generate electrical energy on the basis of a potential difference between two opposite ends occurring when the water moves and evaporates; and a moisture absorption member disposed in the membrane to allow the water to move toward the membrane, the moisture absorption member preferably extending in a longitudinal direction of the membrane, and preferably protruding to the outside of the casing through the inflow hole, and being configured to absorb the water.

In this case, a mesh member may be joined to a surface of the membrane opposite to one side surface of the membrane that is in contact with the moisture absorption member.

Further, an outer surface of the membrane, which is opposite to a position at which the inflow hole is disposed when the membrane is inserted into the casing, may be coated with a coating member to prevent the outer surface of the membrane from being impregnated with the water.

In addition, the coating member may be made of a polydimethylsiloxane (PDMS) material.

Further, bonding members may be provided at two opposite ends of the coating member to maintain a state in which the membrane is wound around an outer surface of the moisture absorption member.

Further, conductive threads may be joined to one side and the other side of the membrane to constitute an electrode.

In addition, a separate cap member may be installed at the upper side with the opening of the casing to prevent the membrane from being withdrawn from the casing.

Further, a cut-out surface, which is made by cutting a partial region, may be provided at one side of a lateral surface of the casing so that the membrane is exposed to the outside.

In order to achieve the above-mentioned object of the present disclosure, an energy generation device may include: the energy generation cell; and a body having an accommodation space configured to accommodate the plurality of energy generation cells, the body being configured such that water is accommodated in a bottom surface of the accommodation space so that the water is supplied to the membrane.

In this case, a separate body separator may be installed in the body to support the energy generation cells and separate water and air.

Further, a plurality of protruding members may be provided on a plate surface of the body separator and have through-holes formed through the plurality of protruding members, the casings of the energy generation cells may be inserted into the through-holes, and the moisture absorption members may protrude through centers of the through-holes.

In addition, a membrane O-ring may be installed around the through-hole to prevent water from being introduced through the through-hole.

Further, a body O-ring, which seals an inner surface of the body, may be installed on a peripheral surface of the body separator.

Further, an input nozzle and an output nozzle, which allow water to be introduced into the accommodation space of the body and then discharged, may be respectively provided at one side and the other side of the body.

In addition, a separate cover may be detachably installed on an upper surface of the body.

As described above, the energy generation cell and the energy generation device including the same according to the present disclosure may additionally harvest electrical energy by using water that is a by-product from the fuel cell system, thereby improving energy generation efficiency, stability, and reliability and reducing fuel consumption by supplying electrical energy as auxiliary energy.

In particular, according to the present disclosure, there is an effect of stably maintaining the arrangement state of the energy generation membrane configured to generate electrical energy and stably maintaining the environment for effectively ensuring the movement (movement by capillarity) and evaporation of the water supplied to the energy generation membrane.

Further, the energy generation cell and the energy generation device including the same according to the present disclosure may obtain an advantageous effect of continuously implementing the generation of electrical energy by the energy generation membrane on the basis of the potential difference created by the movement and evaporation of the water and an advantageous effect of simplifying the structure and providing the ease of maintenance and repair of the device.

In some embodiments, an energy generation cell includes a body having an accommodation space configured to accommodate a plurality of energy generation cells. Each energy generation cell comprises a casing configured to receive water through a bottom inflow hole; a membrane inserted into the casing through an upper opening and configured to generate electrical energy based on a potential difference created as water moves and evaporates; and a moisture absorption member disposed in the membrane, extending to an exterior of the casing through the inflow hole, and configured to draw water toward the membrane. The energy generation cell further includes a cover detachably installed on an upper surface of the body, the cover comprising an inlet through which waste heat is introduced and an outlet through which the introduced waste heat is discharged. The cover is configured to direct the waste heat over the plurality of energy generation cells to enhance evaporation from the membrane.

The cover may have four mounts and is attachable to a lower end of a vehicle or a lower end of a polyethylene foam member so that the energy generation device is disposed at a selected position.

The inlet may be positioned so that waste heat enters the cover and flows over the energy generation ells before exiting through the outlet, thereby accelerating water evaporation.

The waste heat flows in a direction substantially perpendicular to a flow direction of water in the moisture absorption member, enhancing drying of the membrane.

The energy generation device may further include an input nozzle and an output nozzle provided in the body, the input nozzle being configured to introduce water into the accommodation space at a predetermined height and the output nozzle being configured to discharge water so that water level in the body remains substantially constant.

As discussed, the method and system suitably include use of a controller or processer.

In another embodiment, vehicles are provided that comprise an apparatus as disclosed herein.

### BRIEF DESCRIPTION OF THE DRAWINGS

FIG. 1 is an exploded perspective view illustrating a state in which a structure of a membrane of an energy generation cell according to some embodiments of the present disclosure is separated.

FIG. 2 is a perspective view illustrating a structure in which the membrane of the energy generation cell according to some embodiments of the present disclosure is wound around an outer surface of a moisture absorption member.

FIG. 3 is an exploded perspective view illustrating a state in which the energy generation cell according to some embodiments of the present disclosure is disassembled.

FIG. 4 is a perspective view illustrating an overall structure of an energy generation device according to some embodiments of the present disclosure.

FIG. 5 is a top plan view illustrating a structure of the energy generation device according to some embodiments of the present disclosure.

FIG. 6 is a side view illustrating the structure of the energy generation device according to some embodiments of the present disclosure.

FIG. 7 is a perspective view illustrating a structure in which a cover of the energy generation device according to some embodiments of the present disclosure is separated.

FIG. 8 is a perspective view illustrating a structure for coupling the energy generation cell and a separator of the energy generation device according to some embodiments of the present disclosure.

FIG. 9 is a main part enlarged view illustrating an enlarged main part in FIG. 8.

FIG. 10 is a graph illustrating a result of comparing the amounts of production of voltage, current, and power with respect to a change in width of the energy generation cell according to some embodiments of the present disclosure.

FIG. 11 is a graph illustrating a result of comparing the amounts of production of voltage in respect to series connection and parallel connection of the energy generation device according to some embodiments of the present disclosure.

### DETAILED DESCRIPTION

Hereinafter, an energy generation device according to an embodiment of the present disclosure will be described in more detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

The term “conductive polymer” used herein refers to a polymer material that has been treated or formulated to conduct electricity.

The term “potential difference” used herein refers to the difference in electrical potential between two points, measured in volts (V), which drives electric current when a closed circuit is established.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

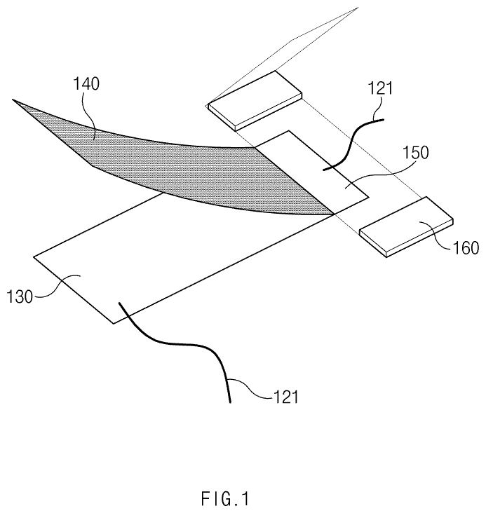

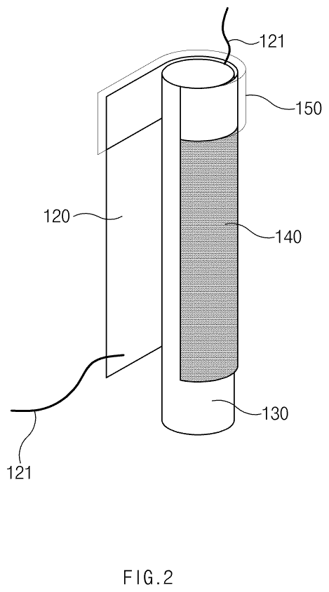

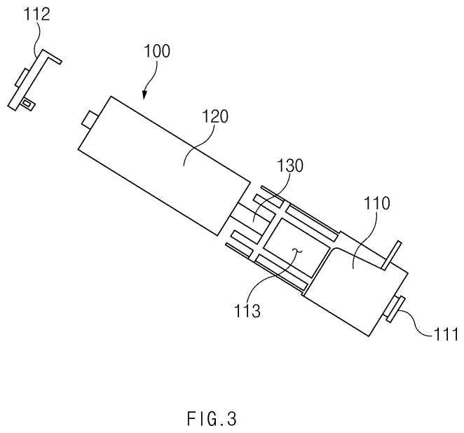

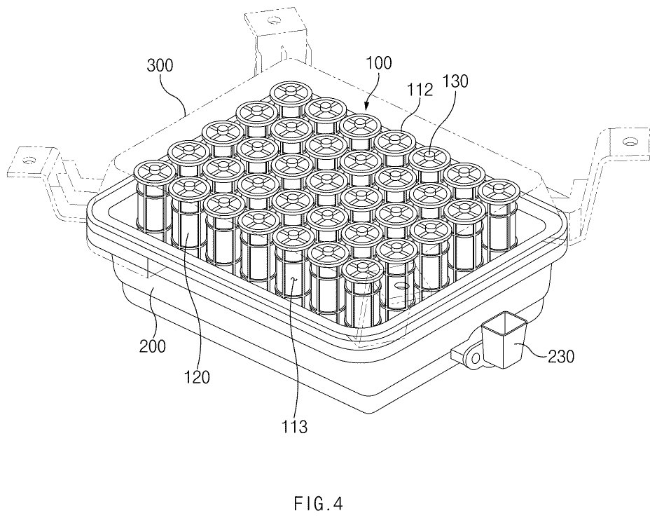

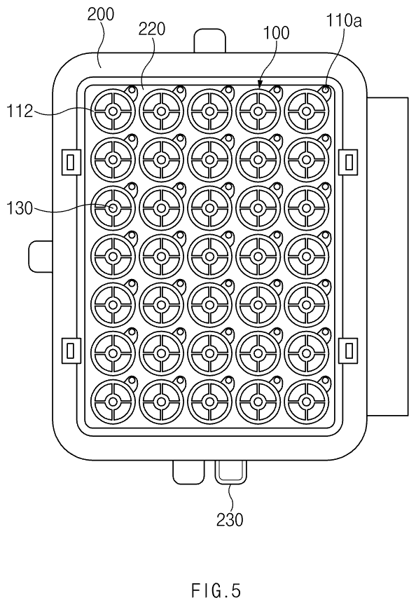

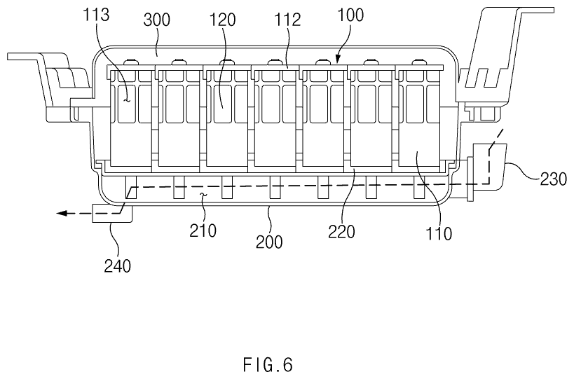

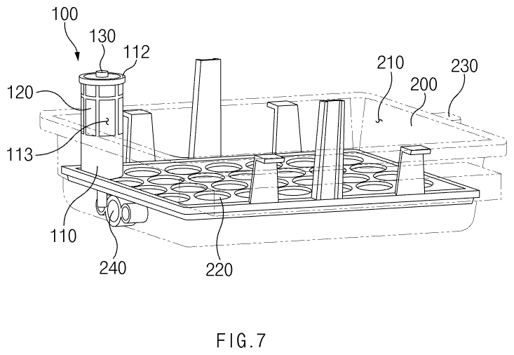

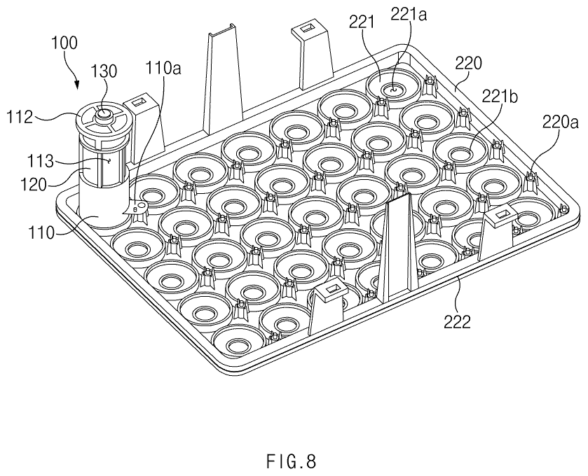

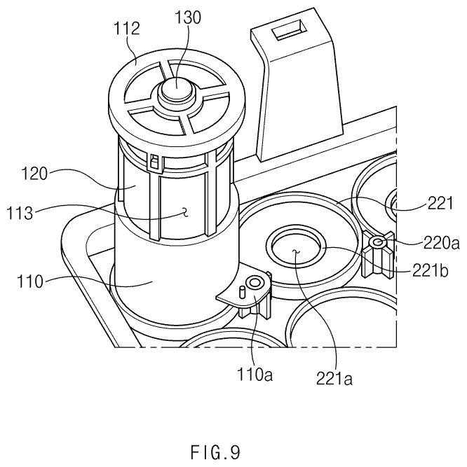

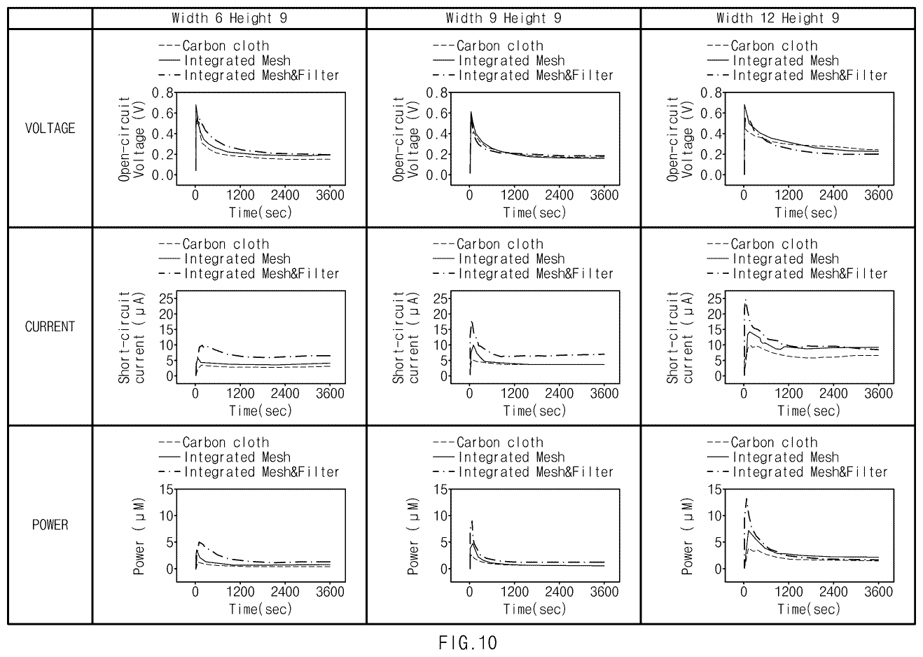

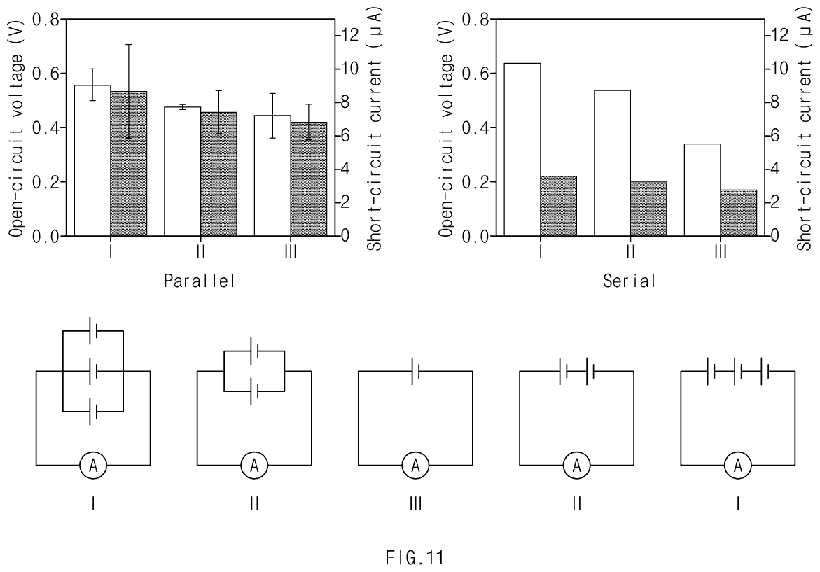

FIG. 1 is an exploded perspective view illustrating a state in which a structure of a membrane of an energy generation cell according to the present disclosure is separated, FIG. 2 is a perspective view illustrating a structure in which the membrane of the energy generation cell according to the present disclosure is wound around an outer surface of a moisture absorption member, FIG. 3 is an exploded perspective view illustrating a state in which the energy generation cell according to the present disclosure is disassembled, FIG. 4 is a perspective view illustrating an overall structure of an energy generation device according to the present disclosure, FIG. 5 is a top plan view illustrating a structure of the energy generation device according to the present disclosure, FIG. 6 is a side view illustrating the structure of the energy generation device according to the present disclosure, FIG. 7 is a perspective view illustrating a structure in which a cover of the energy generation device according to the present disclosure is separated, FIG. 8 is a perspective view illustrating a structure for coupling the energy generation cell and a separator of the energy generation device according to the present disclosure, FIG. 9 is a main part enlarged view illustrating an enlarged main part in FIG. 8, FIG. 10 is a graph illustrating a result of comparing the amounts of production of voltage, current, and power with respect to a change in width of the energy generation cell according to the present disclosure, and FIG. 11 is a graph illustrating a result of comparing the amounts of production of voltage in respect to series connection and parallel connection of the energy generation device according to the present disclosure.

As illustrated in FIGS. 1 to 3, an energy generation cell 100 according to the present disclosure includes a casing 110 having an upper side with an opening and having an inflow hole 111 formed through a bottom surface of the casing 110 so that water may be introduced into the casing 110, a membrane 120 inserted into the casing 110 through the upper side with the opening and configured to generate electrical energy on the basis of a potential difference between two opposite ends occurring when the water moves and evaporates, and a moisture absorption member 130 disposed in the membrane 120 and configured to allow the water to move toward the membrane 120, the moisture absorption member 130 extending in a longitudinal direction of the membrane 120, protruding to the outside of the casing 110 through the inflow hole 111, and being configured to absorb the water.

According to the present disclosure, electrical energy in the form of direct current energy by using a solution, which may be obtained from the nature, or a solution produced by utilizing cationic and anionic super capacitor adsorption mechanisms created during a process in which an ion-containing protonated solvent is adsorbed to a surface of a conductive polymer, and maintaining high potential differences and currents for a long period of time on a hydrophilic fiber membrane coated with a conductive polymer layer by using asymmetric wetting.

Further, according to the present disclosure, the hydrophilic fiber membrane is configured such that the conductive polymer layer is bonded to the surface of the individual fiber, such that the current and voltage are generated by using a shape in which a plurality of energy generation cells is stacked or coupled in parallel/series.

The casing 110, which constitutes the energy generation cell 100, is configured as a cylindrical member having a hollow portion capable of accommodating the membrane 120, and an upper side of the cylindrical member has an opening so that the membrane 120 may be inserted into the casing 110.

The inflow hole 111, which is a passageway through which water is introduced, is formed through the bottom surface of the casing 110. An end of the moisture absorption member 130 to be described below protrudes to the outside of the casing 110 through the inflow hole 111, such that the moisture absorption member 130 comes into contact with water.

Further, in order to prevent the membrane 120 from being withdrawn from the casing 110, a separate cap member 112 is installed at the upper side with the opening of the casing 110. A cut-out surface 113, which is made by cutting a partial region, is provided at one side of a lateral surface of the casing 110 so that the membrane 120 may be exposed to the outside.

In addition, a fixing piece 110a protrudes from an outer surface of a lower portion of the casing 110 by a predetermined length in a diameter direction of the casing 110, and the fixing piece 110a is configured to securely fix the casing 110 to an upper surface of a body separator 220 to be described below. A fastening hole may be formed through a center of the fixing piece 110a and fastened to a protruding piece 220a formed on the body separator 220.

The membrane 120 is inserted into the casing 110 through the upper side with the opening of the casing 110 and generates electrical energy on the basis of a potential difference between the two opposite ends occurring when water moves and evaporates. More specifically, the water, which is supplied from one side of the membrane 120 by means of the moisture absorption member 130, evaporates while moving (moving by capillarity) toward the other side of the membrane 120, such that electrical energy is generated on the basis of a potential difference between the two opposite ends.

A configuration of the membrane 120 will be described with reference to FIGS. 1 and 2. A mesh member 140 is joined to a surface of the membrane 120 opposite to one side surface of the membrane 120 that is in contact with the moisture absorption member 130.

Because the mesh member 140 is joined to the surface of the membrane 120 opposite to one side surface of the membrane 120 that is in contact with the moisture absorption member 130, a speed at which the water moves along the membrane 120 may be increased, and a rate at which the water evaporates may be increased, such that the energy generation efficiency may be improved.

Further, an outer surface of the membrane 120 opposite to a position, at which the inflow hole 111 is disposed when the membrane 120 is inserted into the casing 110, may be coated with a coating member 150 in order to prevent the membrane 120 from being impregnated with water.

The coating member 150 is made of a polydimethylsiloxane (PDMS) material, and an upper end of the membrane 120 coated with the coating member 150 has a positive (+) polarity.

In addition, bonding members 160 are provided at two opposite ends of the coating member 150 to maintain a state in which the membrane 120 is wound around the outer surface of the moisture absorption member 130. The bonding member 160 may be configured as a Kapton tape.

The Kapton tape is mainly manufactured by using a polyimide film and has a thickness of 0.065 mm to 0.08 mm. Even though the Kapton tape has a small thickness, the Kapton tape has high durability, withstands a high temperature of 200° C. or more, and has stable heat resistance and electrical insulation without being deformed even during a thermal process. Therefore, the Kapton tape is considered as a member utilized in various industries.

Further, conductive threads 121 are joined to one side and the other side of the membrane 120 to constitute an electrode. As described above, the upper end of the membrane 120 coated with the coating member 150 has a positive (+) polarity, and a lower end of the membrane 120 opposite to the upper end has a negative (−) polarity.

The moisture absorption member 130 refers to a member disposed in the membrane 120 to allow water to move toward the membrane 120. The moisture absorption member 130 may extend in the longitudinal direction of the membrane 120, protrude to the outside of the casing 110 through the inflow hole 111, and absorb the water.

Further, the moisture absorption member 130, which protrudes to the outside of the casing 110 through the inflow hole 111 of the casing 110, protrudes downward from the body separator 220 through a through-hole 221a, which is formed in a plate surface of the body separator 220, when the casing 110 is installed on the body separator 220 to be described below, such that the moisture absorption member 130 may come into contact with water and absorb the water.

The moisture absorption member 130 may be made of any material as long as the material may absorb water and move the water toward the membrane 120. However, in the case of the energy generation cell 100 according to the present disclosure, the moisture absorption member 130 may be made of a sponge material.

The moisture absorption member 130 may filter out foreign substances contained in the water when the water is supplied to the membrane 120, such that only pure water may be supplied to the membrane 120.

Meanwhile, as illustrated in FIGS. 4 to 9, an energy generation device according to the present disclosure includes the energy generation cells 100, and a body 200 having an accommodation space 210 configured to accommodate the plurality of energy generation cells 100, and water is accommodated in a bottom surface of the accommodation space 210 so that the water may be supplied to the membrane 120.

In this case, because the description of the energy generation cell 100 is identical to the above-mentioned description, the following description will be described with reference to the above-mentioned description. The body 200, which accommodates the energy generation cells 100 and assists in generating electrical energy by allowing the water to pass through the bottom surface of the body, will be described.

The body 200 may have an upper side with an opening and have therein the accommodation space 210 capable of accommodating the energy generation cells 100. The water may be accommodated at a predetermined height in the bottom surface of the body 200.

As illustrated in FIG. 6, the body 200 may be configured as a member having a rectangular shape having an upper side with an opening. An input nozzle 230 and an output nozzle 240, which allow the water to be introduced into the accommodation space 210 of the body 200 and then discharged to the outside, are respectively provided at one side and the other side of the body 200 so that the water may flow in the state in which the water is accommodated at the predetermined height along the bottom surface of the body 200.

Further, it is effective to separately install the body separators 220 in the body 200 to support the energy generation cells 100 and separate water and air.

The body separator 220 is installed at a predetermined height in the body 200 so as to be in contact with an inner surface of the body 200 through the upper side with the opening of the body 200, such that water is accommodated at a lower side of the body 200 based on the body separator 220, and air is present above the body separator 220.

A body O-ring 222, which seals the inner surface of the body 200, is installed on a peripheral surface of the body separator 220 provided to be in contact with the inner surface of the body 200, and the body O-ring 222 may prevent the water from flowing over an upper side of the body 200.

That is, when the water, which is introduced through the input nozzle 230, is accommodated in the bottom surface of the body 200 to a height at which the body separator 220 is installed, the body separator 220 may effectively prevent a water level from increasing any further, and the water is discharged to the outside of the body 200 through the output nozzle 240, such that the water level may be maintained to a predetermined height.

Further, as illustrated in FIGS. 7 to 9, a plurality of protruding members 221 is provided on the plate surface of the body separator 220 and has the through-holes 221a formed therethrough. The casings 110 of the energy generation cells 100 are inserted into the through-holes 221a, and the moisture absorption members 130 protrude through the centers of the through-holes 221a.

The protruding members 221 may be provided to define a predetermined pattern over the entire plate surface of the body separator 220, and the plurality of energy generation cells 100 may be securely fixed to the upper surface of the body separator 220.

An inner diameter of the protruding member 221 is similar to an outer diameter of the casing 110, such that the casing 110 is inserted into the protruding member 221 and fixed to a predetermined degree. In order to more securely fix the casing 110, the fixing piece 110a provided at one side of the casing 110 may be fastened to the protruding piece 220a protruding at a predetermined height from the plate surface of the body separator 220.

The through-hole 221a is formed through the central region of the protruding member 221. It is effective that the through-hole 221a may have a diameter that at least enables the moisture absorption member 130 to pass through the through-hole 221a. It is effective that a membrane O-ring 221b is installed around the through-hole 221a to prevent the water from being introduced through the through-hole 221a.

The membrane O-ring 221b, which is installed as described above, may prevent the water from being introduced toward the upper side of the body separator 220 through the through-hole 221a, such that the water and the air may be assuredly separated by the body separator 220.

Further, a separate cover 300 is detachably installed on the upper surface of the body 200, and the cover 300 may effectively protect the plurality of energy generation cells 100 installed in the body 200 from an external impact.

The cover 300 may have four mounts and be attached to a lower end of a vehicle or a lower end of a PE foam member, such that the energy generation device according to the present disclosure may be disposed at a necessary position.

Further, waste heat, which is generated from an apparatus, such as a vehicle, equipped with the energy generation device according to the present disclosure may be introduced into the cover 300 and then discharged to the outside, such that the water moved to the membrane may quickly evaporate.

A movement direction of the waste heat may be set to various directions. However, in the case of the energy generation device according to the present disclosure, the waste heat may move in a direction perpendicular to the movement direction of the water, such that efficiency in evaporating water may be improved.

Further, it is more effective that an inlet through which the waste heat is introduced into the cover 300 and an outlet through which the introduced waste heat is discharged are not disposed in parallel with each other, such that the waste heat introduced into the cover 300 passes over all the plurality of energy generation cells 100 disposed on the plate surface of the body 200 while forming vortices in the cover.

FIG. 10 is a graph illustrating a result of comparing the amounts of production of voltage, current, and power with respect to a change in width of the energy generation cell according to the present disclosure. As illustrated in FIG. 10, it can be seen that in the case of the energy generation cell 100 according to the present disclosure configured as described above, the amounts of production of the voltage, the current, and the power are increased as the width increases in case that the height of the membrane 120 remains the same.

Further, it can be seen that the generated voltage is high in case that both the mesh member 140 and the moisture absorption member 130 are provided, and the generated voltage is highest in case that the mesh member 140 is provided, in comparison with a case in which the membrane 120 is joined by carbon.

In addition, it can be seen that the amount of generated current is large in case that the mesh member 140 is provided, and the amount of generated current is largest in case that both the mesh member 140 and the moisture absorption member 130 are provided, in comparison with the case in which the membrane 120 is joined by carbon.

However, it can be seen that after a predetermined time elapses, both the voltage and the current converge into the voltage and the current with magnitudes smaller than initial magnitudes in all the three cases.

FIG. 11 is a graph illustrating a result of comparing the amounts of production of voltage in respect to series connection and parallel connection of the energy generation device according to the present disclosure. As illustrated in FIG. 11, it can be seen that the generated current and voltage are increased when the plurality of energy generation devices according to the present disclosure is connected in parallel. However, when the plurality of energy generation devices according to the present disclosure is connected in series, the voltage is increased, but the magnitude of the current does not greatly change.

Meanwhile, according to the present disclosure, one end of the energy generation device is connected to a fuel cell stack (not illustrated), and the other end of the energy generation device is connected to the input nozzle 230, such that water discharged from the fuel cell stack is introduced into the bottom surface of the body 200 through the input nozzle 230.

For reference, the fuel cell stack may be formed to have various structures capable of producing electricity by means of an oxidation-reduction reaction between fuel (e.g., hydrogen) and an oxidant (e.g., air).

For example, the fuel cell stack includes: a membrane electrode assembly (MEA) (not illustrated) having catalyst electrode layers, in which electrochemical reactions occur, at two opposite sides of an electrolyte membrane through which hydrogen ions move; a gas diffusion layer (GDL) (not illustrated) configured to uniformly distribute reactant gases and serve to transfer generated electrical energy; a gasket (not illustrated) and a fastener (not illustrated) configured to maintain leakproof sealability for the reactant gases and the coolant and maintain an appropriate fastening pressure; and a separator (bipolar plate) (not illustrated) configured to move the reactant gases and the coolant.

More specifically, in the fuel cell stack, hydrogen, which is fuel, and air (oxygen), which is an oxidant, are supplied to an anode and a cathode of the membrane electrode assembly, respectively, through flow paths in the separator, such that the hydrogen is supplied to the anode, and the air is supplied to the cathode.

The hydrogen supplied to the anode is decomposed into hydrogen ions (protons) and electrons by catalysts in the electrode layers provided at two opposite sides of the electrolyte membrane. Only the hydrogen ions are selectively transmitted to the cathode through the electrolyte membrane, which is a cation exchange membrane, and at the same time, the electrons are transmitted to the cathode through the gas diffusion layer and the separator which are conductors.

At the cathode, the hydrogen ions supplied through the electrolyte membrane and the electrons transmitted through the separator meet oxygen in the air supplied to the cathode by an air supply device, thereby creating a reaction of producing water. As a result of the movement of the hydrogen ions, the electrons flow through external conductive wires, and the electric current is generated as a result of the flow of the electrons.

As described above, according to the embodiment of the present disclosure, because water (condensate water) discharged from the fuel cell stack is supplied to the input nozzle 230, a separate water supply means for supplying water required to operate the energy generation cell 100 (generate electrical energy) does not need to be provided. Therefore, it is possible to obtain an advantageous effect of simplifying the structure and improving the degree of design freedom and spatial utilization.

The energy generation device according to the present disclosure configured as described above may additionally harvest electrical energy by using water that is a by-product from the fuel cell system, thereby improving energy generation efficiency, stability, and reliability.

While the embodiments, which may be implemented by the present disclosure, have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. An energy generation cell comprising:
a casing having an upper side with an opening and having an inflow hole formed through a bottom surface to allow water to enter the casing;
a membrane inserted into the casing through the upper side with the opening, configured to generate electrical energy based on a potential difference between two opposite ends occurring when the water moves and evaporates; and
a moisture absorption member disposed in the membrane to direct water toward the membrane,, protruding outside the casing through the inflow hole, and being configured to absorb the water.

2. The energy generation cell of claim 1, wherein a mesh member is joined to a surface of the membrane opposite to one side surface of the membrane that is in contact with the moisture absorption member.

3. The energy generation cell of claim 1, wherein an outer surface of the membrane, which is opposite to a position at which the inflow hole is disposed when the membrane is inserted into the casing, is coated with a coating member to prevent the outer surface of the membrane from being impregnated with the water.

4. The energy generation cell of claim 3, wherein the coating member is made of a polydimethylsiloxane (PDMS) material.

5. The energy generation cell of claim 3, wherein bonding members are provided at two opposite ends of the coating member to maintain a state in which the membrane is wound around an outer surface of the moisture absorption member.

6. The energy generation cell of claim 1, wherein conductive threads are joined to one side and the other side of the membrane to constitute an electrode.

7. The energy generation cell of claim 1, wherein a separate cap member is installed at the upper side with the opening of the casing to prevent the membrane from being withdrawn from the casing.

8. The energy generation cell of claim 1, wherein a cut-out surface, which is made by cutting a partial region, is provided at one side of a lateral surface of the casing so that the membrane is exposed to the outside.

9. An energy generation device comprising:
the energy generation cell according to claim 1; and
a body having an accommodation space configured to accommodate the plurality of energy generation cells, the body being configured such that water is accommodated in a bottom surface of the accommodation space so that the water is supplied to the membrane.

10. The energy generation device of claim 9, wherein a separate body separator is installed in the body to support the energy generation cells and separate water and air.

11. The energy generation device of claim 10, wherein a plurality of protruding members is provided on a plate surface of the body separator and has through-holes formed through the plurality of protruding members, the casings of the energy generation cells are inserted into the through-holes, and the moisture absorption members protrude through centers of the through-holes.

12. The energy generation device of claim 11, wherein a membrane O-ring is installed around the through-hole to prevent water from being introduced through the through-hole.

13. The energy generation device of claim 10, wherein a body O-ring, which seals an inner surface of the body, is installed on a peripheral surface of the body separator.

14. The energy generation device of claim 9, wherein an input nozzle and an output nozzle, which allow water to be introduced into the accommodation space of the body and then discharged, are respectively provided at one side and the other side of the body.

15. The energy generation device of claim 9, wherein a separate cover is detachably installed on an upper surface of the body.

16. An energy generation cell comprising:
a body having an accommodation space configured to accommodate a plurality of energy generation cells, each energy generation cell comprising:
a casing configured to receive water through a bottom inflow hole;
a membrane inserted into the casing through an upper opening and configured to generate electrical energy based on a potential difference created as water moves and evaporates; and
a moisture absorption member disposed in the membrane, extending to an exterior of the casing through the inflow hole, and configured to draw water toward the membrane, and
a cover detachably installed on an upper surface of the body, the cover comprising an inlet through which waste heat is introduced and an outlet through which the introduced waste heat is discharged;
wherein the cover is configured to direct the waste heat over the plurality of energy generation cells to enhance evaporation from the membrane.

17. The energy generation device of claim 16, wherein the cover has four mounts and is attachable to a lower end of a vehicle or a lower end of a polyethylene foam member so that the energy generation device is disposed at a selected position.

18. The energy generation device of claim 16, wherein the inlet is positioned so that waste heat enters the cover and flows over the energy generation ells before exiting through the outlet, thereby accelerating water evaporation.

19. The energy generation device of claim 16, wherein the waste heat flows in a direction substantially perpendicular to a flow direction of water in the moisture absorption member, enhancing drying of the membrane.

20. The energy generation device of claim 16, further comprising an input nozzle and an output nozzle provided in the body, the input nozzle being configured to introduce water into the accommodation space at a predetermined height and the output nozzle being configured to discharge water so that water level in the body remains substantially constant.
